(19) United States
(12) Patent Application Publication
(10) Pub. No.: US 2002/0107754 A1
(43) Pub. Date: Aug. 8, 2002

(54) Rule-based system and apparatus for rating transactions

(76) Inventor: Donald Stone, Chapel Hill, NC (US)

Correspondence Address: VENABLE, P.O. Box 34385, Washington, DC, 20043-9998, US

(21) Appl. No.: 09/891,374

(22) Filed: Jun. 27, 2001

Related U.S. Application Data
(60) Provisional application No. 60/214,488, filed on Jun. 27, 2000.

(51) Int. Cl. G06F 17/60

(52) U.S. Cl. 705/26; 705/12

(57) ABSTRACT

A method and apparatus is provided for defining rules in a general-purpose rules engine and applying those rules to the rating of usage records, optionally using external data sets, without reprogramming the engine. Available inputs, data sets, and required outputs are defined and rules are entered into a spreadsheet. The rules are extracted and compiled, then executed. The method and apparatus are applicable to any service that requires billing or other business response based on customer usage of the service(s).

### FIELD OF THE INVENTION

The present invention relates to the fields of telecommunications, online services, and any other business where incoming data (such as customer usage records) must be processed in high volumes to generate billable charges or other business events.

More specifically, the invention relates in certain embodiments to methods and apparatus for defining processing rules in a rule-based system and more particularly, a rule-based system and apparatus for rating any type of communications or on-line transaction.

### BACKGROUND OF THE INVENTION

The traditional large-scale billing system of the past 20 years is characterized by a few common characteristics:

1. Monolithic design. Large systems are constructed from an integrated code-base which includes a number of tightly coupled modules, often including: usage processing, customer management, accounts receivable processing, rating, and bill presentment.

2. Call processing. Large billing systems have specialized to meet the needs of major telephone service providers by providing extensive capabilities for processing telephone usage records (Call Detail Records or CDR's). The CDR data structure provides common information about a call, but is specific to telephone usage (and does not apply to other digital or online services).

3. Expense. Many companies have made large investments into their existing legacy systems and do not want to abandon them for new systems and software. Legacy systems refer to the information resources currently available to the company or organization. They include existing mainframes, personal computers, serial terminals, networks, databases, operating systems, application programs and all other forms of hardware and software that a company may own. Typically they are, like most legacies, of great value to the organization. Unfortunately, most legacy systems cannot easily or economically be extended, modified or otherwise modified to fulfill new requirements

Traditionally, rating systems have been designed to process CDR's by use of rating tables. A table-based approach permits maintainers to update rate plans by changing the data in the tables without having to recode, recompile, and retest the software itself (which is usually proprietary and not accessible to the maintainers in any case).

The major limitation of table-based rating occurs when a previously unknown type of usage must be metered. The existing tables cannot accommodate the attributes and algorithms for rating the new service. Even advanced table-based rating systems such as that described in U.S. Pat. No. 5,923,741 best accommodate telephone call data and ultimately suffer from this limitation. In this case, the only viable option is to recode and recompile the usage-processing subsystems, usually at prohibitive cost and delay because of the monolithic nature of the system.

Over the past few years, Internet technology has moved from a technology of academia to a mature platform capable of guaranteeing secure, performance-driven connectivity. On-line computer systems have become an integral part of many companies' business portfolios. Companies now offer products and services that can be purchased through the Internet. For example, it is now possible for service providers to offer content, such as banking, trading, gaming, etc., application services such as e-mail/messaging, web-hosting, portals, application suites, etc., and network services such as broadband access, Internet telephony, video conferencing, videocasting, etc. The demand for convergent services forces telephone and other connectivity providers to rapidly roll out new offerings while still providing the same advanced customer care and billing.

At the same time, the Internet, like no other selling channel in the past, allows mass customization of product and service offerings. This allows service providers to offer innovative price plans, product bundles, cross-product discounts, and clever promotions.

The requirements for rating on-line transactions are beyond the capabilities of the traditional table-based rating systems. The traditional systems cannot accommodate new types of services which introduce vastly different usage metrics (including bytes, bandwidth, latency, quality of service, etc.). Nor can they implement the logic required for innovative price plans.

One technology that has rarely been applied to CDR rating is rules-based systems. In pricing value-added services, pricing rules used to rate events need to be flexible and easy to customize. Business require that marketing personnel be able to directly create pricing rules, without the intervention of programmers, to quickly respond to very dynamic market conditions. Current general-purpose rule-based systems have been designed for advanced use by technical personnel and therefore cannot meet these demands.

Consequently, there is a need for a rating system that provides easy access to quickly and simply create, test, and modify pricing or other business rules associated with usage of a company's services. The rating system should be able to communicate seamlessly with existing legacy systems and be expandable to account for future growth.

### SUMMARY OF THE INVENTION

A rules-based method for defining pricing plans and/or additional business outputs is provided. The method is generally applicable to problems characterized by:

a set of available input values

a set of required results

a set of rules to compute the required results from the available inputs

A rule-based apparatus is provided to rate usage of an arbitrary next-generation service as a part of a billing system. The pricing rules specify the computations used for pricing. Furthermore, the apparatus implements methods of configuration that enable continued use of pre-existing external systems and data.

The presented apparatus uses a standard spreadsheet as a rule specification interface for a high-performance rule-based system, permitting a rule author to enter rules using a spreadsheet. An intuitive graphical interface allows the pricing rules to be created without the involvement of software developers and testers. The rules are then compiled into a form in which they can be executed efficiently.

In a preferred embodiment, the present invention can price any type of on-line transaction. It can process, discount, cross-product discount and bundle any legacy offering with next generation Internet services, such as application services, internet access, e-commerce, content delivery, wireless data transfer, and the infinite value-added service possibilities that the Internet platform brings. The invention is designed to interface with existing systems and data stores.

The disclosed methods permit information about on-line transactions to be captured from any service element, such as, for example, servers or routers, or mediation systems. Using the captured information, the on-line transaction, or a batch of transactions, is rated using pricing rules and posted to the existing billing system or other destination.

In an exemplary embodiment, a method of applying rules to rate an event is provided. Rules are received by the rating system in a spreadsheet format. The rules are extracted from the spreadsheet format. Next, the rules are applied to available inputs regarding the event to generate required results.

According to another exemplary embodiment, a method of generating rules used to rate an event is provided. In the method, characteristics of input usage records, supplemental data, and required results for the event are identified. Available inputs for rating the event are selected from the characteristics of the input usage records and the supplemental data. A rule author is presented with an option to select one or more available inputs to be processed by the rules. The rules created based upon the available inputs are applied to rate the event.

The present invention may also include computer readable program means to perform the aforementioned methods.

According to another exemplary embodiment of the invention, an apparatus for rating events is provided. The apparatus comprises a definition module for creating rules that define required results based on available inputs, means for extracting the rules from the price definition module, and means for applying the rules to an event to rate the event.

In a further embodiment, the price definition module includes a spreadsheet interface. Moreover, means for identifying input usage records, supplemental data, and required results for the event and means for presenting selected ones of the input usage records and the supplemental data to a rule author via the spreadsheet interface may be provided. Additionally, means for dynamically testing the rules using native functions of the spreadsheet interface may also be provided.

### BRIEF DESCRIPTION OF THE DRAWINGS

FIG. 1 is an overview of an embodiment of the invention during rating;

FIG. 2 is an overview of the technical architecture of an embodiment of the invention;

FIG. 3 is an example of an embodiment of a configuration file

FIG. 4 is a detailed view of the components comprising a repository illustrating the invention interfacing with existing systems;

FIG. 5 is a graphical user interface of the price definition module;

FIG. 6A is a graphical user interface of the price definition module for adding a service;

FIG. 6B is a graphical user interface of the price definition module for selecting a rated output

FIG. 7 is a graphical user interface of the price definition module for creating a price rule;

FIG. 8 is an example of the creating of a price rule;

FIG. 9 is a graphical user interface of the price definition module for saving a price rule; and

FIG. 10 is a component diagram and example of the function of the compensation cache.

### DETAILED DESCRIPTION OF THE INVENTION

The present invention generally relates to rule-based systems that can be used to solve computation problems. As described above, problems in this category typically have a set of available inputs. A set of required results are to be determined from these inputs. The required results are computed from the available inputs using a set of rules. One example of a problem in this category is rating usage of a service as part of billing for that service. The invention is particularly suited for this environment and is described below in this context. Of course other applications of the present invention are also possible.

When rating the usage of a service with this rule-based system, for example, the set of available inputs may include all the information collected during the use of the service, along with all the information known about the service user. Of course, other information may be included in the available inputs. The set of required results may include the charge for the service along with any other information required to generate a bill for the service. The set of rules, or more specifically, pricing rules, specify the computation to be performed to generate to required results. For example, a pricing rule may specify a $1.00 per minute charge for use of a service, which would result in a $5.00 charge when the service was used for 5 minutes.

A system embodying the present invention allows a rule author to enter pricing rules into the system and then executes the pricing rules for a stream of available input values. In a preferred embodiment, the present invention utilizes an intuitive graphical user interface (GUI) to allow the rule author to create pricing rules. Preferably, the rule specification GUI of the present invention behaves identically to a standard spreadsheet, such as MS Excel®, available from the Microsoft Corporation, Redmond, Wash., U.S.A. Utilizing a spreadsheet system for entering the pricing rules has a number of advantages over other approaches. Spreadsheets are well understood by a wide segment of the general computer user population. They provide a simple way to express pricing rules acceptable to rule authors who would be intimidated by a more traditional expression language. Furthermore, spreadsheets allow rule authors wide flexibility in organizing a computation through visual presentation of information and intermediate calculations. Spreadsheets also allow rule authors to directly validate the correctness of the specified rule by observing the behaviour of the spreadsheet in response to a variety of test inputs.

The spreadsheet rule interface in some embodiments may be incorporated into a rating system that can price any type of on-line transaction. In such an embodiment of the invention, the rating engine c(an process, discount, cross-product discount and bundle any legacy offering with next generation Internet services, such as application services, internet access, e-commerce, content delivery, wireless data transfer, and the infinite value-added service possibilities that the Internet platform brings. The invention permits data collection, provisioning, and customer management to be implemented via integration with existing systems. The invention can thus accept data in a variety of industry standard formats or proprietary API's. Information about transactions can be captured from any service element, such as, for example, servers or routers, or mediation systems. The transaction, or a batch of transactions, is then rated using pricing rules and posted to the existing billing or other system. The rated transactions may be presented in a standardized form allowing service providers to add rating of new services using their existing system infrastructure.

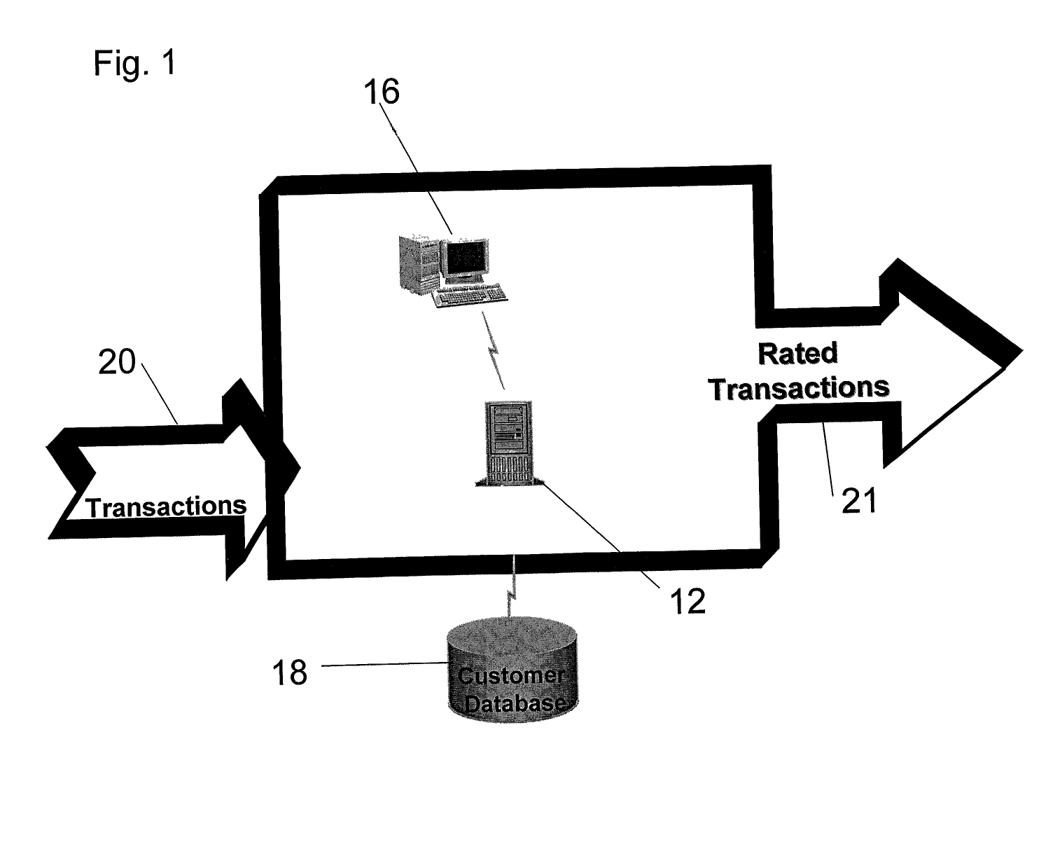

Referring to FIGS. 1-4, a more detailed description of an embodiment of the invention is given. FIG. 1 is a high level view of an embodiment of the invention as usage events are rated. The rating engine 12 runs as an application and controls the pricing of an on-line transaction, for example. In a typical embodiment, the invention is implemented as a client/server application where the client rules-specification interface preferably runs on a common desktop operating system such as Windows 98/NT/2000 platforms and the rating engine server operates on a powerful server such as a Sun Solaris. The rating engine 12 may interface with existing legacy systems, such as database 18, to receive information required to rate the transaction and to output the required results.

The price definition module 16 is used by the rule author to define pricing rules used to rate the transactions. The rating engine 12 communicates with the price definition module 16, when new rules are specified or existing rules modified, as described in more detail below. Once created, the pricing rules are communicated to the rating engine 12 and compiled. The rating engine 12 rates the transaction 20 according to the appropriate pricing rule and outputs the required results, i.e. rated transaction 21.

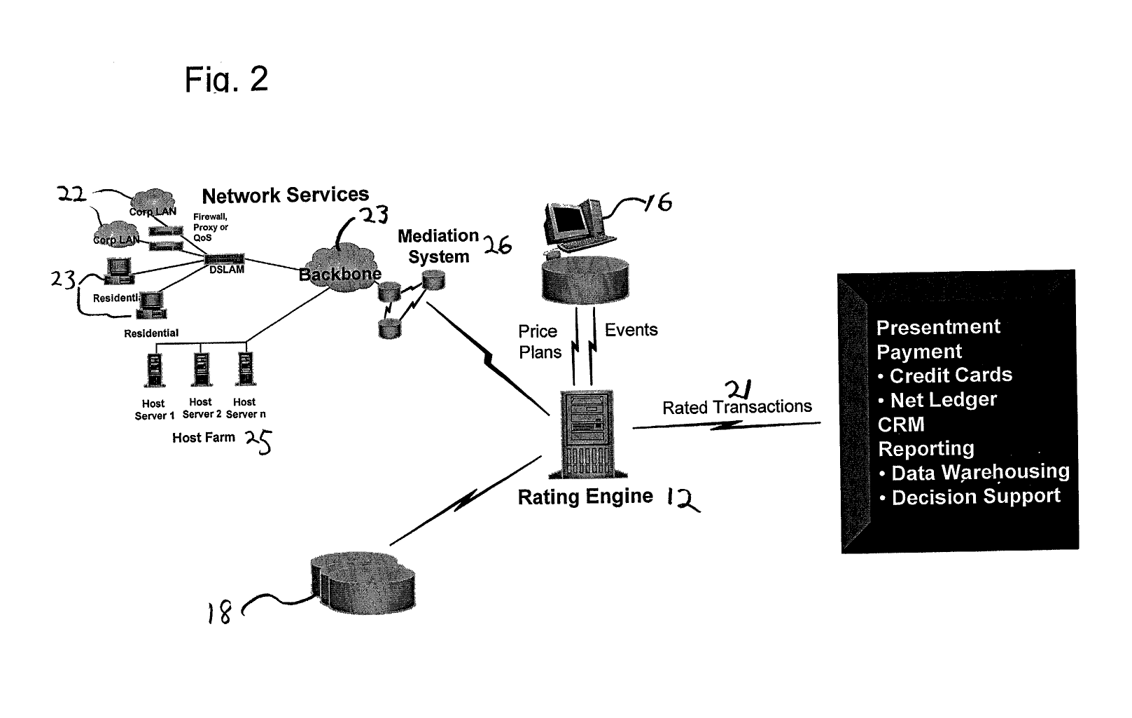

FIG. 2 provides a more detailed example of the architecture of a system according to an embodiment of invention. In this example, a service provider is providing network and application hosting services. Different customers, such as residential customers 22 typically operating on a PC and corporate customers 23 typically operating on a LAN, connect to server farm 25 through the service provider's backbone 24.

At some point, the customers 22 or 23 request a service from a network or server maintained by the service provider. This occurrence is called a usage event (or more simply, an event) and typically needs to be priced in order to accurately charge the customer. Usage events occur whenever a selected action takes place on the network. For example, events can occur whenever a customer logs into or out of the network, downloads a file, accesses a particular part of the network or performs any other function defined as an event. The events are usually transaction events, such as file downloads from the host servers, or time-based events, such as teleconferencing, for which charges accumulate based on the period of time the customer remains on line. Of course, any other type of on-line transaction is also contemplated by the invention.

When an event occurs, the network or server creates a record containing information about the event. The record contains attributes of the event; these are typically defined by the server or network equipment manufacturer that creates the usage record. There may be many different types of events that occur and records that are generated. However, records for the same type of events typically contain the same kinds of data and attributes. For example, when a teleconference is begun, an IP switch in the service provider's network is activated. This IP switch creates a record of the teleconference initiation. The record typically includes a minimal amount of information, such as the time the switch was activated and the start IP address of the call. A record of a teleconference will always include the time the switch was activated, which is a time, and a start IP address, which is an IP address. Thus, when an event occurs, the rating engine 12 can expect these attributes of the event to be recorded.

In order for the record to be used by the rating engine 12, additional information may be required. A mediation system 26 may be provided to augment the record with other information. Mediation system 26 then provides the event data to the rating engine 12. In addition to or in place of the mediation system, the rating engine can also source usage information from any type of network element or hosting server.

After gathering the appropriate information from different sources such as database(s) 18 and the record, the rating engine 12 prices the transaction using an appropriate pricing rule. The pricing rules have preferably been previously defined into the system by using the price definition module, described below. The rating engine 12 determines which pricing rule is applied to a particular transaction. The rating engine applies the appropriate pricing rule and the rated transaction is output to a location that may be designated in the rule. Often, the designated location is an existing billing system. However, other output destinations are also possible. For example, the output can be directed to bill a credit card or place the rated transaction on a net ledger. In any event, the billing system will require certain information to generate a bill. This information may include an account number, the amount to be billed, a description of the charge, and other details about the event and customer. This information includes what is generally referred to as the required results. What data is included in the required results will vary depending on the event and billing system. After receiving the required results, the external billing system can then process the rated transaction in its usual manner.

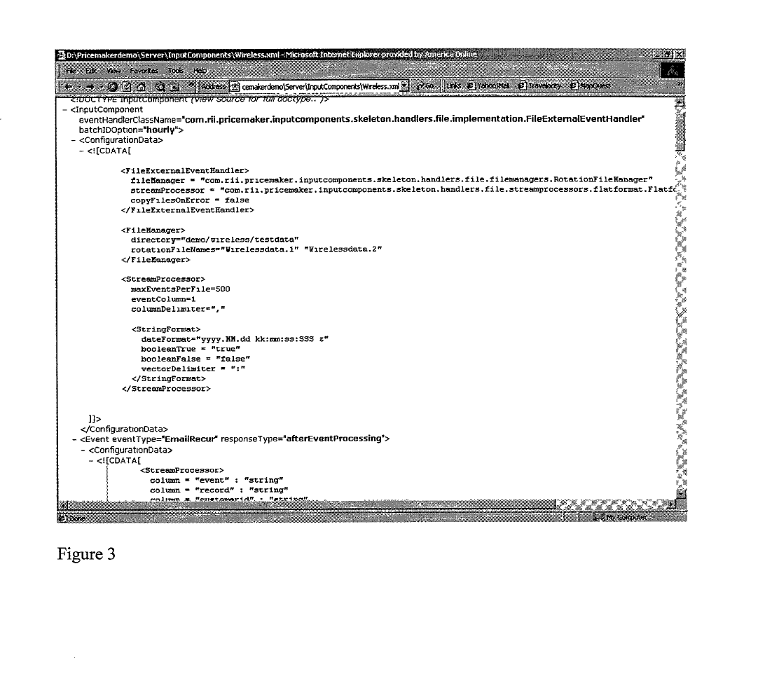

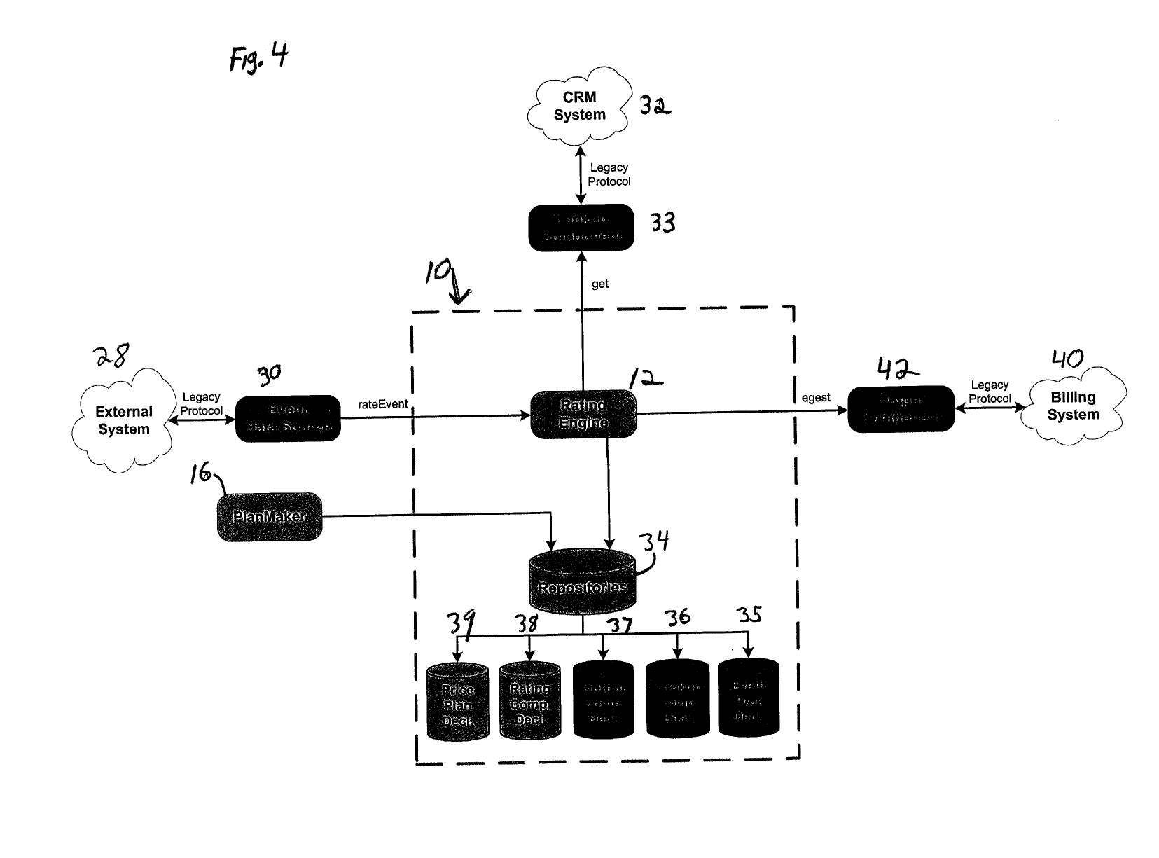

Turning now to FIGS. 3-4, a more detailed description of the operation of the server-based system 10 and the interaction of the server-based system 10 with existing legacy systems will now be given. The server-based system 10 may be implemented as a software application, such as a JAVA2 or C++ application, that runs on a server. Reference number 28 represents the network that records usage events, such as mediation systems or network elements. The event data is transmitted from the network 28 to the server-based system 10. The protocol used for the event data transmission depends on the particular network 28; many different protocols are possible. The function of event data source 30 is to read one or more protocols native to external system 28 and convert it into a generic set of name-value pairs recognized by the server-based system 10. The event data source 30 may be thought of as a type of translator. The event data source 30 can be customized to translate the protocol of the network 28 into a protocol used by the server-based system 10. The event data source 30 converts the event data and outputs it in a particular format used by the pricing module 10, for example, SOAP.

The different types of information that can be expected in a record of a particular usage event are characterized in repository 34. This information is typically supplied by an integrator at the time the system is set up (or by a maintainer as additional external systems are added). FIG. 3 demonstrates an example embodiment of such information as it might be supplied to define a usage record received in a comma-delimited flat file. It should be apparent to a skilled practitioner that similar configuration options might be used to accomplish integration of the server-based system with existing systems through open APIs, CDR, IPDR, Oracle, ODBC, JDBC, CIBER, HTTP, or other communications protocols.

Information needed to rate the event that is not included in the event data is gathered by performing look-ups into various databases. For example, a customer name may be obtained from an IP address by looking the IP address up in a look-up source that associates IP addresses to customer names. A look-up source is typically a database, however the term also includes any system that may contain information. A chain of look-ups may be performed until all the necessary information is obtained.

Look-up source 32 is usually a part of the existing legacy system and contains additional details about the customer, such as name address, etc. and details about the services. Typically, it operates using the legacy protocol. For the server-based system 10 to be able to interface with the look-up source 32, a lookup component interface 33, i.e. translator is provided. The look-up component interface 33 enables the server-based system 10 to query the lookup source 32 in the legacy system. This is done using configurations similar to FIG. 3 as described above. The lookup component interface 33 is preferably capable of handling typical protocols such as SQL, HTTP, XML, and text files and providing them to the server-based system 10. In a preferred embodiment, it also includes caching capabilities. An output component interface 42 similar to the lookup component interface is also provided.

It should be understood to a skilled practitioner of the arts that many types of event data sources 30, lookup sources 32, and output components 42 exist. More than one of each is often used in configuring the system. FIG. 4 presents only one of each in order to simplify the discussion.

Repository 34 is maintained by server-based system 10 to store pricing information and system data (further discussion of the source of this data appears below). In one embodiment, repository 34 is an XML database containing information as to what events are to be priced and what pricing rules are to be used for particular events and customers. The repository also specifies the attributes and data types to be generated after an event occurs. FIG. 4 shows different repositories 35, 36, 37, 38, and 39 representing data stores that must be available to server-based system 10 and that may be part of repository 34. In the embodiment shown, five repositories are present, an event type 35, a lookup component 36, an output component 37, a rating component 38, and a price plan 39. A system integrator may add information in the event type, look-up component, and output component repositories when the system is installed or connected to additional external systems. The event type repository 35 contains the different types of events that are to be rated. Lookup component repository 36 specifies what external data such as customer information is available to rate the particular event. The output component repository 37 specifies where the rated transaction should be output. The rating component repository 38 contains the pricing rules. The price plan repository 39 specifies what pricing rules are to be applied and brings all the information in the other repositories together.

Once the information about the event is gathered, the server-based system 10 can rate the event. This is done by applying the appropriate pricing rule. The pricing rules were preferably created earlier by use of the GUI described below and are available in the rating repository 38. The price plan repository 39 contains information on what pricing rules are to be used in pricing a particular event or group of events for a customer. The server-based system 10 accesses these repositories (or in a preferred embodiment, maintains a cache) and rates the event. The process of rating the event will be described below. After the event is rated, it is output to a standard or proprietary output record as may be defined by the rules. The output component repository 37 contains the details as to what output records must be generated to meet the requirements of the consuming external systems.

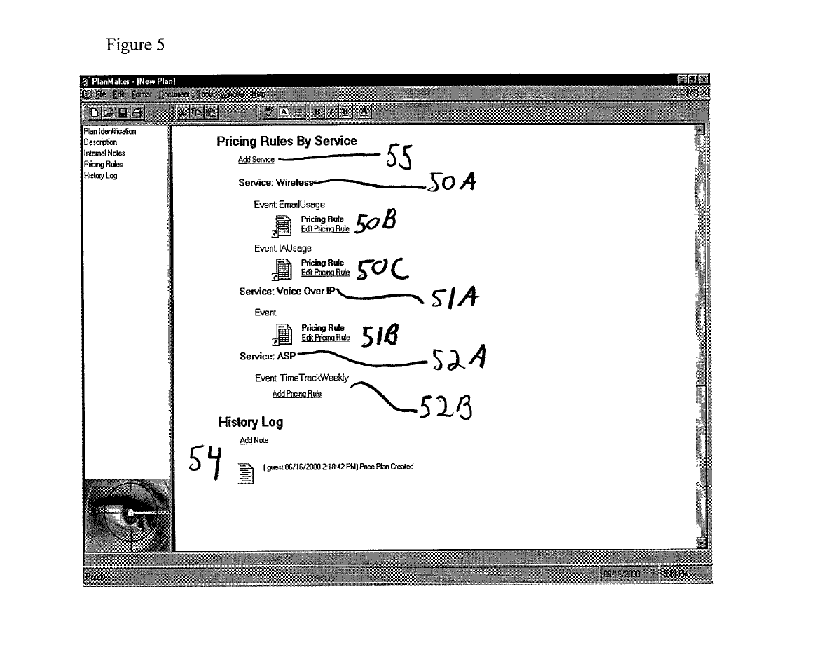

Thus far an architecture for rating events has been described. Turning now to FIG. 5-9, a process for writing pricing rules will now be elaborated. As mentioned above, the present invention allows for custom definition of pricing rules. The rule author may enter the pricing rules via the price definition module. FIGS. 5-9 show realizations of GUIs preferably used in the price definition module 16.

FIG. 5 demonstrates the top-level navigation where the rule author selects the type of event for which he wishes to create or modify a rule. Here, a set of services 50a, 51a, and 52a provided by a company, along with accompanying pricing rules are displayed. In the example shown, price plans have been created for wireless, voice over IP, and ASP services. Details of the different events which are to be rated for a particular service are displayed on subsequent screens under the respective service. In this example, the events that trigger rating when using the wireless service 50a are e-mail usage 50b or IA usage 50c. In a preferred implementation, a history log 54 that displays the different versions of the pricing rule along with who created or modified the rule will also be provided.

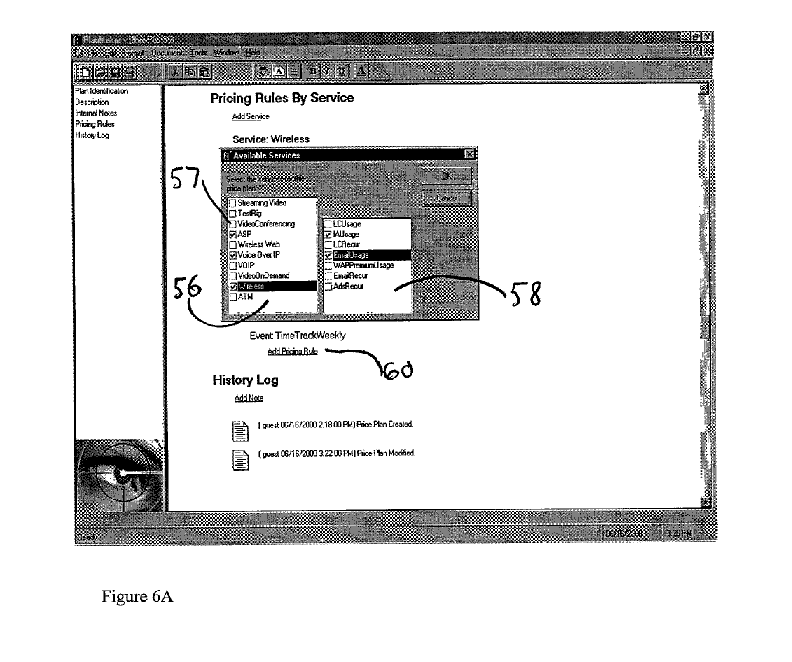

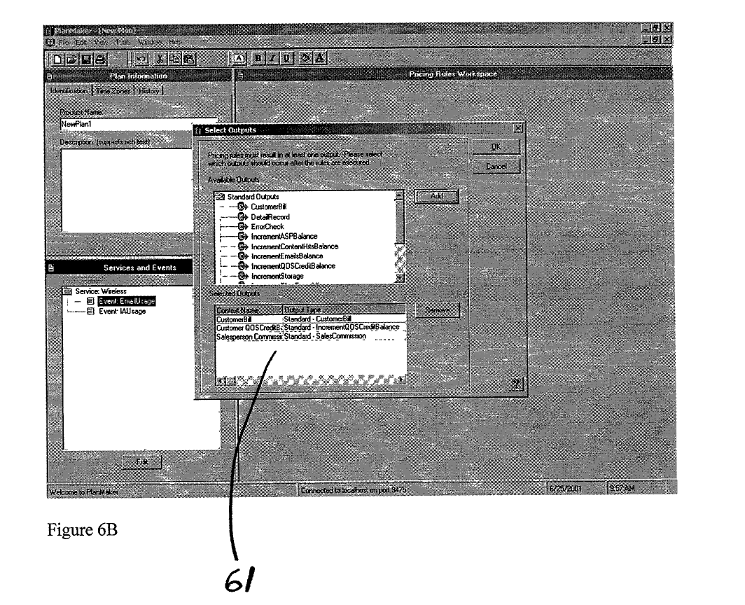

Different services and events can be added, deleted or modified by clicking on the appropriate link. To create a price plan for a new service, the user clicks on the Add Service link 55. The screen shown in FIG. 6A is then displayed. A set of available services of the company is displayed in field 56. In a preferred implementation, this selection list is populated automatically based on configuration data supplied earlier while setting up the event data sources 30. The rule author selects the appropriate services or group of services by clicking on the corresponding box 57 to the left of the desired service. Double clicking on a service listed in field 56 will highlight the service, as is shown for the “wireless” service in FIG. 6. Field 58 then displays the different events that may occur in conjunction with the highlighted service. These may include interim records and end-of-session summaries. The rule author can then select the appropriate events to trigger one or more billing record or other output. For example, if pricing a teleconference, the event to be billed for can be the completion of the call. In FIG. 6A, e-mail usage and IA usage are selected as events to be rated. Each service can have one or more usage events defined that trigger a rating rule.

After selecting the desired services, events, and outputs, a pricing rule is created by clicking on the Add pricing rule link 60. As a first step, the rule author can select from different available outputs from the rating rule. The selection list specifies where the rated transaction is sent. The outputs can include, for example, the existing legacy billing system, a credit card clearing house to automatically bill the customers credit card, a frequent flier account to credit the account with miles for a purchase or many other possibilities. In a preferred implementation, this selection list is populated automatically based on configuration data supplied earlier while setting up the output components 42. In the example shown in FIG. 6B, the IA Usage event will potentially generate output records to bill the customer, give the customer a Quality of Service adjustment, and/or increment the salesperson's commission payments, as shown in field 61.

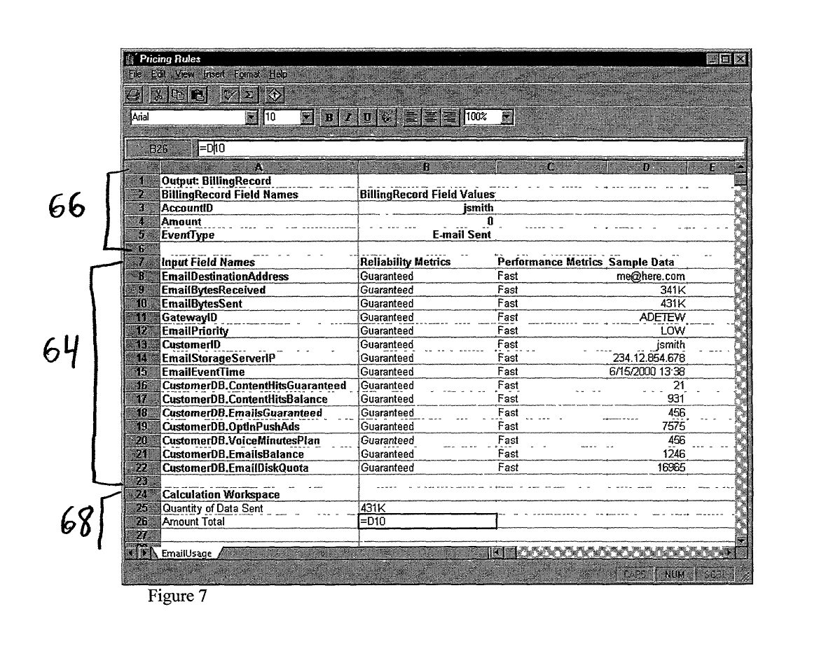

Next, the rule author is presented with the rules-specification GUI. Preferably, the GUI is a spreadsheet like interface as exemplified in FIG. 7. In a preferred implementation, the rule author is presented with a partially initialized spreadsheet. Cells of the spreadsheet corresponding to available inputs are identified and initialized with sample or test data of the appropriate data type. For example, the “EmailDestinationAddress” cell may be initialized with an e-mail address. In a preferred implementation, the example data was collected earlier as part of the configuration of event data source(s) 30. Cells corresponding to required results are also identified, but left blank. The rule author is allowed to use the rest of the spreadsheet as he sees fit. However, all required result cells must be assigned some value, either a constant value or a formula, by the rule author.

In a preferred embodiment, before the spreadsheet is provided to the rule author, each available input and required result for the event is associated with a single cell or a single row during the creation of the partially-initialized spreadsheet by the system. For example, the “EmailDestinationAddress” input value of FIG. 7 is associated with the “A8” cell of the spreadsheet. Single-valued input/results are associated with a single cell. Multi-valued input/results are associated with a full row. In addition, a table is stored in memory that maps the input and result cells to a well-defined data type (e.g., Integer, Boolean, Date, String, etc.). These associations will be used by the system later after the rule author has created in the rules.

The spreadsheet shown in FIG. 7 is separated into several different sections. Section 64 contains the information provided as input to server-based system 10, typically as part of the usage record. The types of information shown in field 64 will vary depending on the type of usage event providing the information. The types of information available are identified by name and test values are given. The values shown in field 64 are not the real values, because at this point the actual customer usage events have not begun to happen. The test values are provided to help develop the pricing rule. For example, the test values can be used when creating a pricing rule to preview how the pricing rule will evaluate a particular event.

Section 66 contains the required results that are output to the billing system 40, for example. These values may be defined by the pricing rule and may be gleaned from the input field 64. A calculation workspace 68 is provided for the rule author to enter extended free-form calculations. For example, a VLOOKUP into a small table might be entered directly in the calculation workspace 68.

In a preferred implementation, lookup components 33 accessing additional external data may be accessed automatically upon receipt of the input record. This is the case with all of the “CustomerDB” attributes in the example input 64; this data was previously looked up from a supplemental data store upon receipt of the usage event. Look-up data may also be accessed dynamically by the rule author by use of a custom function in the pricing rules.

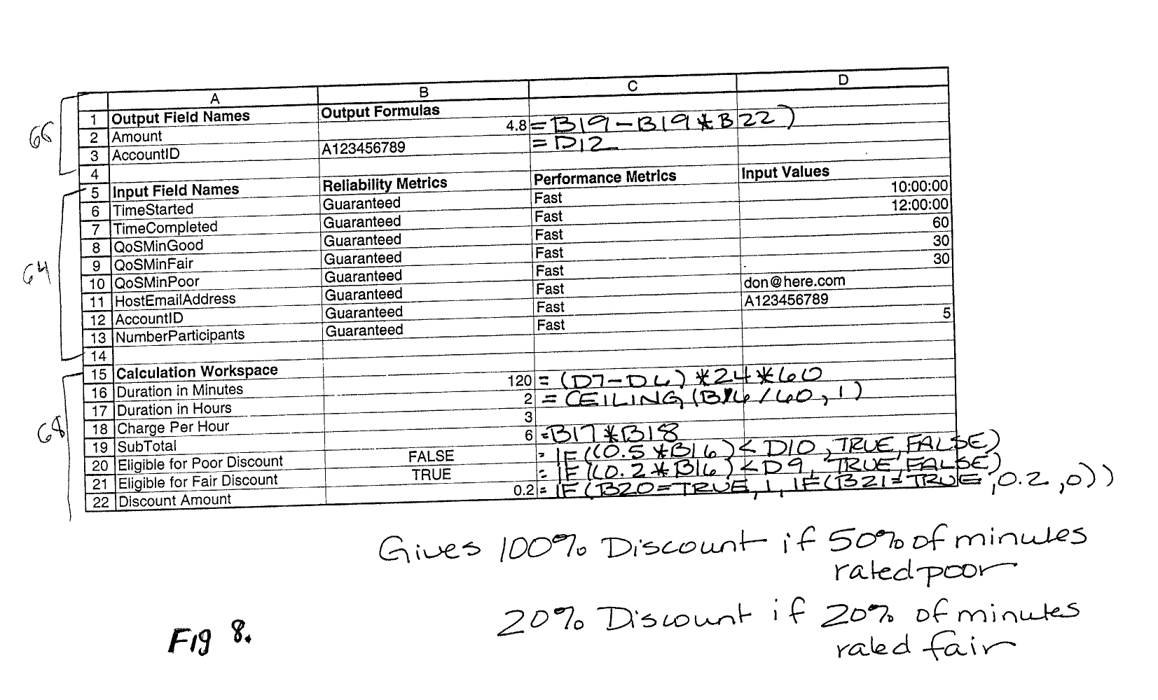

FIG. 8 gives an example of the creation of a pricing rule. In this example, a pricing rule is created for a teleconference. Here, the output field 66 contains the amount to be billed and the account ID. This field includes the required result cells that are defined by the rule author on the spreadsheet, as mentioned above. At runtime, information in these fields is provided to the output component 42 and then passed on to the external consumer. As mentioned above, input field 64 contains the available details about the usage event. For the teleconference in this example, the input field 64 includes the time the teleconference was started, the time it was completed, the number of minutes with good, fair and poor quality of service, the customer's account ID, and the number of participants in the teleconference. Test values are provided for each of these input fields. The pricing rules can be written using any of the information in the input fields, along with other desired information, at the rule author's discretion.

In this example, the teleconference will be billed based on its duration. Assume a discount of 100%, a free call, will be given if 50% of the minutes are rated poor and a 20% discount will be given if 20% of the minutes are rated fair. Calculation workspace 68 illustrates an example of the formulas used to define the pricing rule. The spreadsheet may be Excel®, for example, and the formulas are correspondingly written in Excel. Of course other types of spreadsheets are also possible. Column B, rows 16-22 show the results of the formulas with the appropriate formula shown to the immediate right. Since the start time and completion time are given as clock times in the input fields, these times must be converted to hours and to minutes for the desired pricing rule. Rows 16 and 17 show the appropriate formulas to accomplish this conversion. A charge per hour is for the teleconference is selected and entered by the rule author into cell B 18. A sub-total, before any discounts are applied, is shown in cell B 19. Cells C20-22 illustrate the formulas used to calculate any applicable discount, based on the above quality requirements. After the calculations are completed, the amount to be billed and customer ID are defined in the required results field 66 in cells B2 and B3.

When computation rules are expressed in a spreadsheet, the rule author can validate the correctness of the rule set at the time the rule is created by observing the behavior of the spreadsheet in response to a variety of test inputs. Thus, in the above example, the rule author can immediately see the effect providing discounts has on the final bill (a 20% discount off of the normal $6.00 price in B2). According to the test values provided in the example, the customer would be billed $4.80 for the teleconference having the characteristics set forth in the input field. The rule author can easily evaluate this pricing rule, detect any errors and make any necessary changes.

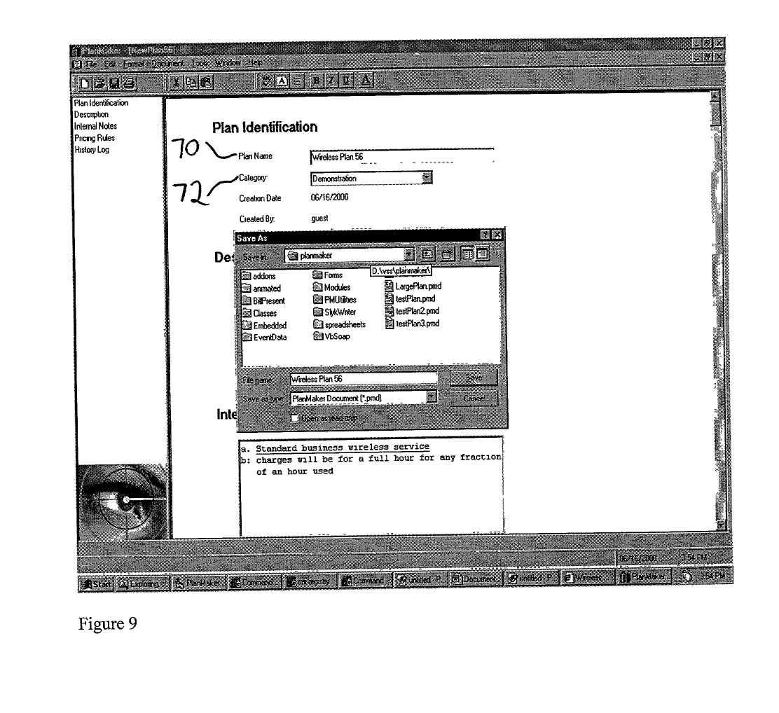

After the rule author is satisfied with the pricing rule, it is saved to the server and into the repository. FIG. 9 show a screen shot of the saving option. A name for the price plan is entered in field 70 and a category of the price plan is entered into field 72.

With reference to FIGS. 5-9, a method and apparatus for rule authoring has been described. After the rules have been created, it is necessary to realize a method for efficiently using the rules. In a preferred embodiment of the present invention, after the price rule is created and saved, the price module extracts the price rules from the spreadsheet and prepares to execute them.

Among other benefits, the present invention can enforce dynamic type checking on the formulas defined by the rule author. This is helpful to enable high-performance execution of the rule sets. Expensive execution-time checks are avoided, and calculations can be effectively optimized. Dynamic type checking has the additional advantage of allowing the rule author to find type violations at authoring time rather than at execution time.

According to a method of one embodiment of the invention, a sweep is first performed over all the cells in the spreadsheet to construct a table with one entry for each defined cell. Each entry maps a cell name to the contents of that cell. Formulas are parsed and represented as an expression tree. The parsing may be done with a simple recursive descent parser.

Next, the pricing rules are compiled. This may be accomplished by performing the following steps.

Step 1—Type check the input values. Each cell associated with a single-valued input is checked to ensure that it contains a constant value of the correct datatype. That For example, the “Start Time” cell is checked to ensure it contains a time. Each row associated with a multi-valued input is checked to ensure that it: 1) contains at least one defined cell, and 2) all cells in the row are constants of the correct datatype.

Step 2—Build dependency graph. A directed graph is constructed in which the vertices correspond to the cells in the spreadsheet and the edges correspond to a dependency of one cell on another, that is, the formula that defines the first cell refers to the other cell).

Step 3—Check for cycles. The dependency graph is checked to ensure that it is acyclic. Cycles are not permitted. If a cycle is detected an error message is generated.

Step 4—Discard unreachable cells. Reachability walks are performed starting from each defined cell associated with a result value. All cells in the dependency graph that were not reached are discarded.

Step 5—Topological sort. An order must be chosen in which to execute the cells. The order must ensure that every cell is executed after all cells on which it depends. Since the dependency graph is acyclic, it defines a partial order. A topological sort produces a total ordering on the cells consistent with the partial order. This ordering defines the sequence in which the cells will be executed, an execution sequence.

Step 6—Type check all cells. In the order defined by the execution sequence, the data type of the each cell is determined. If the cell contains a constant, the data type is given. If the cell contains a formula, then the data type is determined by analyzing the expression tree. Each node in the expression tree will be one of: 1) a constant (with a given data type), 2) a cell reference (the data type has already been determined since the cell will precede this cell in the execution sequence), 3) a spreadsheet function (supported functions take well defined input types and return well defined result types), or 4) a unary or binary operator (which also take well-defined input types and return well defined result types).

Step 7—Type check the result values. Each cell or row associated with a required result value is checked to ensure that it has the correct data type.

Step 8—Discard input cells. All cells that correspond to input values are removed from the execution sequence.

Step 9—Constant expression evaluation. In the order defined by the execution sequence, each cell is checked for the existence of constant subexpressions. A constant subexpression is any part of a cell's expression tree that does not contain a reference to a non-constant cell. Whenever a constant subexpression is found, it is evaluated and replaced with the resulting constant. If the entire expression tree associated with a cell is found to be a constant, the entry for the cell in the execution sequence is replaced by an entry for a constant cell.

After the pricing rules are compiled, a final execution sequence may be stored in an intermediate form. In a preferred embodiment, this intermediate form might be executable machine code. The pricing rules can then be executed to rate the event. In another embodiment, a pricing rule set is executed by:

creating a table whose entries map cell names to values

initializing the table with the available input values

evaluating the cells in the order specified by the execution sequence, adding a constant to the table if the cell specifies a constant, or evaluating the expression tree using values already in the table if the cell specifies a formula.

determining the values of the required results by extracting the associated cell values from the table.

The above computer-implemented methods are computationally simple and may be repeated millions of times in the processing of usage records in a realistic environment such as FIG. 2.

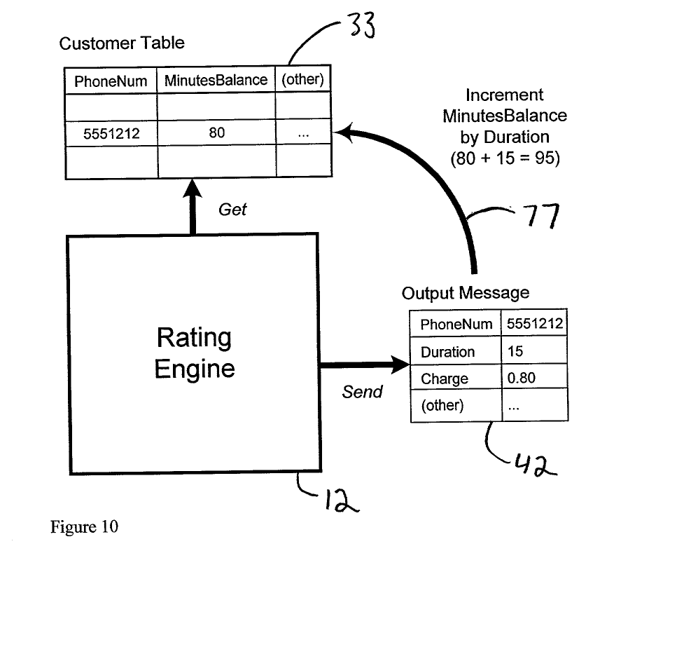

Here before the basic integration, rule definition and execution capabilities of the system have been described. Let us now turn to FIG. 10 for disclosure of an advanced data management technique.

The role of the event data source 30, lookup component 33, and output component 42 have been previously described. A preferred embodiment of the server-based system 10 includes caching capabilities for data passing through any of these (particularly the lookup component). However, simple caching may be dangerous in situations where the data accessed by the lookup component 33 is frequently changing. This situation arises frequently in rating, where an account balance is impacted as each usage event is rated. Many interesting pricing plans base charges on and alter customer account balances. Examples include: 1) plans with free usage included within the monthly fee, 2) plans with several price tiers, and 3) plans that grant discounts based on monthly usage or poor QoS.

In order to accomplish caching in such a situation, a method and an apparatus (referred to as the “compensation cache”) of updating the cache may be provided. The compensation cache defines relationships between the data in look-up sources and the values sent as outputs from the rating engine. In this situation, each message to the output component should change the cached value in the look-up source. For example, FIG. 10 illustrates required results generated by the rating engine for an event, here a telephone call. As shown in the figure, a 15 minute call has been placed from telephone number 555-1212. The amount the customer is charged for calls may vary based on the total number of minutes the customer has used the service. Therefore, in this example, a fifteen-minute call should increment a customer's minutes balance from 80 to 95. Arrow 77 in FIG. 10 illustrates the communication from the output component to the look-up component. The new minutes balance may then be used in determining the rate to apply to future calls made from 555-1212.

In a preferred embodiment, configuration of the compensation cache relationships is done as part of the basic component declarations for lookup components 33 and output components 42. Consider the following example fragments from a Lookup and an Output configuration file:

<LookupComponent name=“Subscriber” >

<InputParameter name=“CallingPhoneNumber” />
<LookupAttribute name=“MinutesBalance”

balanceAttribute=“true” />

</LookupComponent>

In this Lookup declaration, the MinutesBalance attribute is specified as a balance attribute, which means that it will be kept up to date in the compensation cache.

<OutputComponent name=“BillingMessage” >

<InputParameter name=“CallingNumber” />
<Input Parameter name=“Duration” />
<InputParameter name=“Charge” />
<LookupBinding name=“Subscriber” >

<WriteBack lookupName=“CallingPhoneNumber”

outputName=“CallingNumber” updateType=“key” />

<WriteBack lookupName=“MinutesBalance” outputName=“Duration”

updateType=“increment” />

</LookupComponentBinding>

</OutputComponent>

In this embodiment, the Output declaration specifies the relationship between the Lookup and the Output with the “LookupBinding” specification. This specification includes the relationships between parameters of the Output to both (1) all keys of the Lookup and (2) balance attributes of the Lookup.

Accordingly a method and apparatus for defining rules in a rule-based system and for rating any type of communications or on-line transaction is provided. The method and system can provide easy access to quickly and simply create, test, and modify pricing or other business rules associated with usage of a company's services. A rating system utilizing the present invention can communicate seamlessly with existing legacy systems and expand to account for future growth.

While the invention has been described in terms of a preferred embodiment in a specific system environment, those skilled in the art recognize that the invention can be practiced, with modification, in other and different hardware and software environments within the spirit and scope of the invention and may be used to process a wide variety of data.

The role of the event data source 30, lookup component 33, and output component 42 have been previously described. A preferred embodiment of the server-based system 10 includes caching capabilities for data passing through any of these (particularly the lookup component). However, simple caching may be dangerous in situations where the data accessed by the lookup component 33 is frequently changing. This situation arises frequently in rating, where an account balance is impacted as each usage event is rated. Many interesting pricing plans base charges on and alter customer account balances. Examples include: 1) plans with free usage included within the monthly fee, 2) plans with several price tiers, and 3) plans that grant discounts based on monthly usage or poor QoS.

In order to accomplish caching in such a situation, a method and an apparatus (referred to as the “compensation cache”) of updating the cache may be provided. The compensation cache defines relationships between the data in look-up sources and the values sent as outputs from the rating engine. In this situation, each message to the output component should change the cached value in the look-up source. For example, FIG. 10 illustrates required results generated by the rating engine for an event, here a telephone call. As shown in the figure, a 15 minute call has been placed from telephone number 555-1212. The amount the customer is charged for calls may vary based on the total number of minutes the customer has used the service. Therefore, in this example, a fifteen-minute call should increment a customer's minutes balance from 80 to 95. Arrow 77 in FIG. 10 illustrates the communication from the output component to the look-up component. The new minutes balance may then be used in determining the rate to apply to future calls made from 555-1212.

In a preferred embodiment, configuration of the compensation cache relationships is done as part of the basic component declarations for lookup components 33 and output components 42. Consider the following example fragments from a Lookup and an Output configuration file:

<LookupComponent name=“Subscriber” >

<InputParameter name=“CallingPhoneNumber” />
<LookupAttribute name=“MinutesBalance”

balanceAttribute=“true” />

</LookupComponent>

In this Lookup declaration, the MinutesBalance attribute is specified as a balance attribute, which means that it will be kept up to date in the compensation cache.

<OutputComponent name=“BillingMessage” >

<InputParameter name=“CallingNumber” />
<InputParameter name=“Duration” />
<InputParameter name=“Charge” />
<LookupBinding name=“Subscriber” >

<WriteBack lookupName=“CallingPhoneNumber”

outputName=“CallingNumber” updateType=“key” />

<WriteBack lookupName=“MinutesBalance” outputName=“Duration”

updateType=“increment” />

</LookupComponentBinding>

</OutputComponent>

In this embodiment, the Output declaration specifies the relationship between the Lookup and the Output with the “LookupBinding” specification. This specification includes the relationships between parameters of the Output to both (1) all keys of the Lookup and (2) balance attributes of the Lookup.

Accordingly a method and apparatus for defining rules in a rule-based system and for rating any type of communications or on-line transaction is provided. The method and system can provide easy access to quickly and simply create, test, and modify pricing or other business rules associated with usage of a company's services. A rating system utilizing the present invention can communicate seamlessly with existing legacy systems and expand to account for future growth.

While the invention has been described in terms of a preferred embodiment in a specific system environment, those skilled in the art recognize that the invention can be practiced, with modification, in other and different hardware and software environments within the spirit and scope of the invention and may be used to process a wide variety of data.

What is claimed is:

1. A method of defining and applying rules to rate an event, comprising:
receiving rules in a spreadsheet format;
extracting the rules from the spreadsheet format; and
applying the rules to available inputs regarding the event to generate required results.

2. The method of claim 1, further comprising converting the extracted rules to a form enabling rapid execution.

3. The method of claim 1, further comprising,
presenting a partially populated spreadsheet to a rule author; and
receiving a fully populated spreadsheet from the rule author.

4. The method of claim 1, wherein the extracting step comprises:
constructing a table with an entry for each cell defined in the spreadsheet;
compiling the rules from the spreadsheet; and
storing a final execution sequence for the rules.

5. The method of claim 4, wherein the final execution sequence is stored in an intermediate form.

6. The method of claim 5, wherein the intermediate form is executable machine code.

7. The method of claim 4, wherein the compiling step comprises:
type-checking values for the available inputs;
building a dependency graph for the cells;
checking for cycles;
discarding cells in the dependency graph that are unreachable;
performing a topological sort for the cells;
type-checking the cells;
type-checking values for the required results;
discarding cells corresponding to values for available inputs; and
performing constant expression evaluation.

8. The method of claim 1, wherein the applying step further comprises:
creating a table whose entries map names of cell in the spreadsheet to values;
initializing the table with values for the available inputs;
evaluating the cells in an order specified by an execution sequence; and
determining values of the required results by extracting values of cells associated with the required results from the table.

9. The method of claim 8, wherein the evaluating step comprises:
adding a constant to the table if the cell specifies a constant, or evaluating an expression tree using values already in the table if the cell specifies a formula.

10. A method of generating rules used to rate an event, comprising:
identifying characteristics of input usage records, supplemental data, and required results for the event;
identifying available inputs for rating the event from the characteristics of the input usage records and the supplemental data;
presenting a rule author with an option to select one or more available inputs to be
processed by the rules; and
receiving the rules created based upon the available inputs.

11. The method of claim 10, wherein the rules define the required results based on the available inputs.

12. The method of claim 10, further comprising presenting a spreadsheet interface to a rule author to create the rules.

13. The method of claim 12, further comprising extracting the rules from the spreadsheet format.

14. The method of claim 12, wherein the spreadsheet is partially initialized.

15. The method of claim 10, wherein the available inputs are derived from usage data regarding the event.

16. The method of claim 10, wherein the available inputs are derived from supplemental data sources.

17. The method of claim 10, wherein the required results include information necessary to generate a bill for the event.

18. The method of claim 12, wherein the spreadsheet is partially initialized with test values for at least some of the available inputs.

19. The method of claim 18, further comprising providing functionality to dynamically test the rules using native functions of the spreadsheet.

20. The method of claim 10, further comprising:
identifying supplemental data affected by the required results; and
automatically updating the affected supplemental data based on the required results.

21. The method of claim 20, wherein the updating step comprises:
linking the affected supplemental data to the associated required results;
forwarding the associated required results to a database storing the affected
supplemental data upon production of the associated required results; and
modifying the affected supplemental data based on the associated required results.

22. A method of defining rules for rating an event, comprising:
identifying information available about the event;
initializing a spreadsheet with the available information;
presenting the spreadsheet to a rule author;
receiving a populated spreadsheet defining rules;
extracting the rules from the populated spreadsheet; and
storing the rules.

23. The method of claim 22, further comprising
receiving event information regarding the occurrence of the event; and
applying the rules to the event to generate results.

24. The method of claim 22, wherein the rules are applied upon receipt of information that the event has occurred.

25. The method of claim 22, wherein the rules define required results based on the available information.

26. The method of claim 25, wherein the required results include billing information.

27. The method of claim 26, further comprising forwarding the required results to a bill processor.

28. The method of claim 22, further comprising maintaining knowledge of the state of external data sets which are affected by rule execution, without the necessity to repeatedly query those external data sets.

29. The method of claim 23, further comprising:
identifying data affected by the results; and
automatically updating the data upon production of the results.

30. A computer useable information storage medium storing computer readable program code means for causing a computer to perform the steps of:
receiving rules in a spreadsheet format;
extracting the rules from the spreadsheet format; and
applying the rules to available inputs regarding the event to generate required results.

31. An apparatus for rating events, comprising:
a definition module for creating rules that define required results based on available inputs;
means for extracting the rules from the price definition module; and
means for applying the rules to an event to rate the event.

32. The apparatus according to claim 31, wherein the price definition module includes a spreadsheet interface.

33. The apparatus according to claim 31, further comprising means for identifying input usage records, supplemental data, and required results for the event and means for presenting selected ones of the input usage records and the supplemental data to a rule author via the spreadsheet interface.

34. The apparatus according to claim 32, further comprising means for dynamically testing the rules using native functions of the spreadsheet interface.
